(19) United States
(12) Patent Application Publication
(10) Pub. No.: US 2006/0050751 A1
(43) Pub. Date: Mar. 9, 2006

(54) Optical transmission device for controlling optical level of wavelength multiplexed light and method thereof

(75) Inventor: Takeshi Sakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/995,263

(22) Filed: Nov. 24, 2004

(30) Foreign Application Priority Data
Sep. 6, 2004 (JP) 2004-258772

(51) Int. Cl. H01S 3/13

(52) U.S. Cl. 372/32; 372/29.02

(57) ABSTRACT

An optical level of each wavelength of a wavelength multiplexed light is monitored and the optical level of each wavelength is adjusted so that the above monitored value gets closer to a target value. Further, an optical level of each wavelength after the coupling of the adjusted lights is monitored, in total. The target value of each wavelength is updated in accordance with the above monitored value.

### BACKGROUND OF THE INVENTION

1. Field of the Invention

The present invention relates to an optical transmission device for controlling an optical level in an amplifying repeater system for a wavelength multiplexed light, and a method thereof.

2. Description of the Related Art

In an amplifying repeater system for a wavelength multiplexed light, slope and shape of the spectrum of a wavelength multiplexed light output from an optical amplifier are varied when the number of wavelengths or the wavelength arrangement of the light passing through an optical amplifier is varied due to an increase/decrease (addition/removal) of wavelengths constituting a wavelength multiplexed light. In a system in which optical amplifiers having equal characteristics are connected in a multistage manner, the above variation of the slope and the shape of the spectrum accumulate to lead to a great variation of the optical level (optical power) at the receiving terminal with respect to the number of wavelengths and the residual wavelength after the variation of the number of wavelengths and the wavelength arrangement (an wavelength to be operated further). Because such a variation of the optical level can bring about a deterioration of a transmission quality, damages on optical components or the like, the optical level has to be adjusted back to an optimum level with the possible minimum time by following the variation of the optical level as precisely as possible.

Because a rapid variation of the optical level occurs at the time of transmission failure or an increase/decrease of the wavelength, an optical device and a control circuit capable of responding rapidly are needed in order to detect and control the optical level. For the above reason, in a transmission system for a wavelength multiplexed light which has to respond to a rapid variation of the optical level, a configuration is employed in which photodetectors and optical attenuators at the points such as a transmitting terminal, an optical add-drop multiplexing node, or the like, at which respective wavelengths constituting the wavelength multiplexed light are branched, are provided so that the rapid variation of the optical level can be absorbed as much as possible.

Also, in a system in which redundancy switching for a transmission line is conducted by detecting the loss of signal during the operation at a time of a transmission failure, a lowered optical level of each wavelength has to be followed instantaneously so that a configuration is employed in which photodetectors at the portions in which the light is branched into respective wavelengths are used to detect such lowerings.

Japanese unexamined patent application publication No. 11-103287 and Japanese unexamined patent application publication No. 09-064819 relate to monitoring/controlling of an optical signal in a transmission system for a wavelength multiplexed light.

In the above conventional amplifying repeater for a wavelength multiplexed light, there are following problems.

In order to comply with the requirement for the higher functionality and the lower cost, an amplifying repeater for a wavelength multiplexed light has to realize a transmission of longer distance, multistaging of repeaters, an increase of the number of optical add-drop multiplexers (OADM), an increase of the number of wavelengths and the like. In order to realize the above, the transmission characteristics of an optical transmission system have to be improved to the maximum. However, in the above described configuration with photodetectors and optical attenuators, there are some of problems and the room for improvement.

(1) Variation in a downstream side from the adjustment point, especially variation of tilt shape or the like due to the variation of the number of wavelengths and wavelength arrangement can not be absorbed because of the configuration in which a control toward the predetermined target value is conducted at the transmitting side.

(2) Optical output level of amplifier or optical signal-noise-ratio (OSNR) at the receiving terminal can not be improved although optical input level of amplifier can be made constant at a transmitting terminal.

(3) Generally, a photodetector does not present an absolute accuracy of optical level so that delicate adjustment of the optical level in advance is required and to realize such an adjustment, a great deal of man hours or the costly facility is needed.

### SUMMARY OF THE INVENTION

It is an object of the present invention to improve the optical level control using a photodetector and an optical attenuator in order to realize a rapid adjustment for an optical level with higher accuracy, in an amplifying repeater system for a wavelength multiplexed light.

A first optical transmission device of the present invention comprises a storing device, a first monitor device, an optical attenuation device, a coupling device, a second monitoring device and a controlling device, and transmits a wavelength multiplexed light obtained by multiplexing lights of plural wavelengths through an optical transmission line including media with optical loss and optical amplifying devices for compensating for the loss by such media.

The storing device stores a target value of an optical level of each wavelength, and the first monitoring device monitors an optical level of each wavelength, and the optical attenuating device adjusts an optical level of each wavelength so that a value monitored by the first monitoring device gets closer to the target value stored in the storing device. The coupling device couples the adjusted lights of respective wavelengths, and the second monitoring device monitors, in total, an optical level of each wavelength after the coupling, and the controlling device updates the target value stored in the storing device in accordance with the value monitored by the second monitoring device.

A second optical transmission device of the present invention comprises a storing device, a first monitoring device, an optical attenuating device, a coupling device and a controlling device, and transmits a wavelength multiplexed light obtained by multiplexing lights of plural wavelengths through an optical transmission line including media with optical loss and optical amplifying devices for compensating for the loss by such media.

The storing device stores a target value of an optical level of each wavelength, and a first monitoring device monitors an optical level of each wavelength, and the optical attenuating device adjusts an optical level of each wavelength so that a value monitored by the first monitoring device gets closer to the target value stored in the storing device. The coupling device couples the adjusted lights of respective wavelengths, and the controlling device receives information of optical signal-noise-ratio obtained by monitoring, in total, the optical signal-noise-ratio of each wavelength after the coupling and updates the target value stored in the storing device in accordance with the above received information.

A third optical transmission device of the present invention comprises a storing device, a first monitoring device, an optical attenuating device, a coupling device, a second monitoring device, a controlling device and a third monitoring device, and transmits a wavelength multiplexed light obtained by multiplexing lights of plural wavelengths through an optical transmission line including media with optical loss and optical amplifying devices for conducting automatic gain control in order to compensate for the loss by such media.

The storing device stores a target value of an optical level of each wavelength, and the first monitoring device monitors an optical level of each wavelength, and the optical attenuating device adjusts an optical level of each wavelength so that a value monitored by the first monitoring device gets closer to the target value stored in the storing device. The coupling device couples the adjusted lights of respective wavelengths. The second monitoring device monitors, in total, an optical level or an optical signal noise-ratio of each wavelength after the coupling, and the third monitoring device monitors an optical level of a total power after the coupling, at the input side or the output side of the optical amplifying device. The controlling device updates the target value stored in the storing device in accordance with the value monitored by the second monitoring device and the third monitoring device.

### BRIEF DESCRIPTION OF THE DRAWINGS

FIG. 1 is a principle view of an optical transmission device of the present invention;

FIG. 2 shows a configuration of a transmitting section;

FIG. 3 is a flow chart for a first control;

FIG. 4 shows a configuration of a first optical add-drop multiplexing section;

FIG. 5 is a flow chart for a second control;

FIG. 6 shows a configuration of a system including a receiving section;

FIG. 7 is a flow chart for a third control;

FIG. 8 shows a configuration of a system including a second optical add-drop multiplexing section;

FIG. 9 is a flow chart for a forth control;

FIG. 10 shows a configuration of a third optical add-drop multiplexing section;

FIG. 11 is a flow chart for a fifth control;

FIG. 12 shows a configuration of a forth optical add-drop multiplexing section;

FIG. 13 is a flow chart for a sixth control;

FIG. 14 shows a configuration of a fifth optical add-drop multiplexing section; and

FIG. 15 is a flow chart for a seventh control.

### DESCRIPTION OF THE PREFERRED EMBODIMENTS

Hereinafter, preferred embodiments of the present invention will be explained in detail, referring to the drawings.

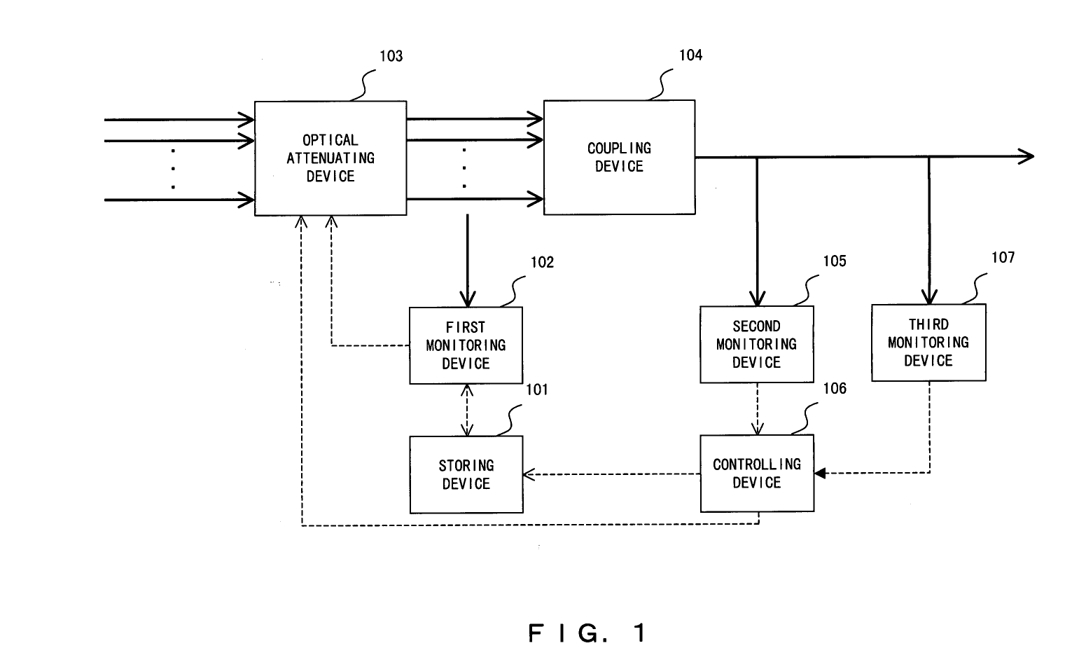

FIG. 1 shows a configuration of first, second and third optical transmission devices of the present invention.

The first optical transmission device of the present invention comprises a storing device 101, a first monitoring device 102, an optical attenuating device 103, coupling device 104, a second monitoring device 105 and a controlling device 106, and transmits a wavelength multiplexed light obtained by multiplexing lights of plural wavelengths through an optical transmission line including media with optical loss and optical amplifying devices for compensating for the loss by such media.

The storing device 101 stores a target value of an optical level of each wavelength, and a first monitoring device 102 monitors an optical level of each wavelength, and the optical attenuating device 103 adjusts an optical level of each wavelength so that a value monitored by the first monitoring device 102 gets closer to the target value stored in the storing device 101. The coupling device 104 couples the adjusted lights of respective wavelengths, and the second monitoring device 105 monitors, in total, an optical level of each wavelength after the coupling, and the controlling device 106 updates the target value stored in the storing device 101 in accordance with the value monitored by the second monitoring device 102.

According to the first optical transmission device, a rapid adjustment of an optical level can be realized by employing a configuration that the optical attenuating devices 103 adjusts (i.e. raises/lowers the optical level) an optical level of each wavelength so that a value monitored by the first monitoring device 102 gets closer to the target value. Further, the controlling device 106 updates the target value in accordance with the second monitoring device 102 so that the target value is optimized in accordance with a change of situation during the operation.

The second optical transmission device of the present invention comprises a storing device 101, a first monitoring device 102, an optical attenuating device 103, a coupling device 104 and a controlling device 106, and transmits a wavelength multiplexed light obtained by multiplexing lights of plural wavelengths through an optical transmission line including media with optical loss and optical amplifying devices for compensating for the loss by such media.

The storing device 101 stores a target value of an optical level of each wavelength, and a first monitoring device 102 monitors an optical level of each wavelength, and the optical attenuating device 103 adjusts an optical level of each wavelength so that a value monitored by the first monitoring device 102 gets closer to the target value stored in the storing device 101. The coupling device 104 couples the adjusted lights of respective wavelengths, and the controlling device 106 receives information of optical signal-noise-ratio obtained by monitoring, in total, the optical signal-noise-ratio of each wavelength after the coupling and updates the target value stored in the storing device 101 in accordance with the above received information.

According to the second optical transmission device, similarly to the first optical transmission device, a rapid adjustment of an optical level is realized so that the target value is optimized in accordance with a change of situation during the operation. Further, by monitoring and transmitting to the optical transmitting device an optical signal-noise-ratio of each wavelength after the coupling at optical add-drop multiplexing nodes or receiving nodes provided in the downstream side from the optical transmission device, the target value is optimized in accordance with a change of situation of the downstream side so that the OSNR at the nodes of the down stream side can be improved.

The third optical transmission device of the present invention comprises a storing device 101, a first monitoring device 102, an optical attenuating device 103, a coupling device 104, a second monitoring device 105, a controlling device 106 and a third monitoring device 107, and transmits a wavelength multiplexed light obtained by multiplexing lights of plural wavelengths through an optical transmission line including media with optical loss and optical amplifying devices for conducting automatic gain control in order to compensate for the loss by such media.

The storing device 101 stores a target value of an optical level of each wavelength, and a first monitoring device 102 monitors an optical level of each wavelength, and the optical attenuating device 103 adjusts an optical level of each wavelength so that a value monitored by the first monitoring device 102 gets closer to the target value stored in the storing device 101. The coupling device 104 couples the adjusted lights of respective wavelengths, and the second monitoring device 105 monitors, in total, an optical level of each wavelength or an optical signal noise-ratio after the coupling, and the third monitoring device 107 monitors an optical level of a total power after the coupling, at the input side or the output side of the optical amplifying device. The controlling device 106 updates the target value stored in the storing device 101 in accordance with the value monitored by the second monitoring device 105 and the third monitoring device 107.

According to the third optical transmission device, similarly to the first optical transmission device, a rapid adjustment of an optical level is realized. Further, even when the optical amplifying device is conducting automatic gain control (AGC), the target value is optimized in accordance with a change of situation during the operation with the output optical level of the optical amplifying device.

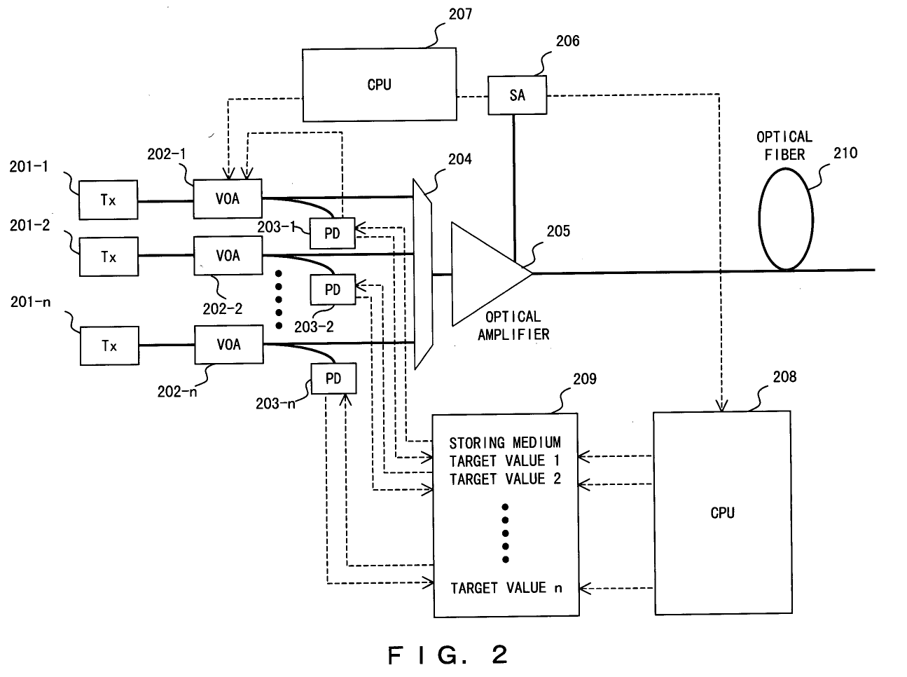

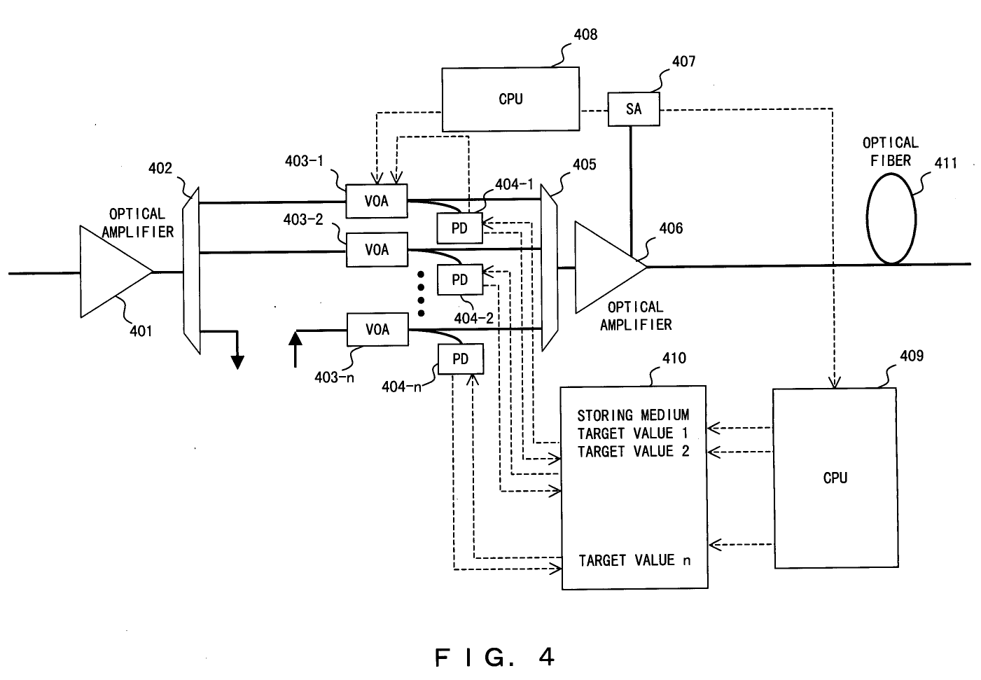

The optical amplifying device correspond to an optical amplifier 205 of FIG. 2 or an optical amplifier 406 of FIG. 4, for example, which will be described later. The storing device 101 corresponds to a storing medium 209 of FIG. 2 or a storing medium 410 of FIG. 4, for example. The first monitoring device 102 corresponds to photodetectors (PD) 203-i of FIG. 2 (i=1,2, . . . n) or PD 404-i of FIG. 4 (i=1,2, . . . n), for example. The optical attenuating device 103 corresponds to valuable optical attenuators VOAs 202-i of FIG. 2 (i=1,2, . . . n) or valuable optical attenuators VOAs 403-i (i=1,2, . . . n) of FIG. 4, for example.

The coupling device 104 corresponds an optical coupler 204 of FIG. 2 or an optical coupler 405 of FIG. 4, for example. The second monitoring device 105 corresponds to a spectrum analyzer (SA) 206 of FIG. 2 or a SA 407 of FIG. 4, for example.

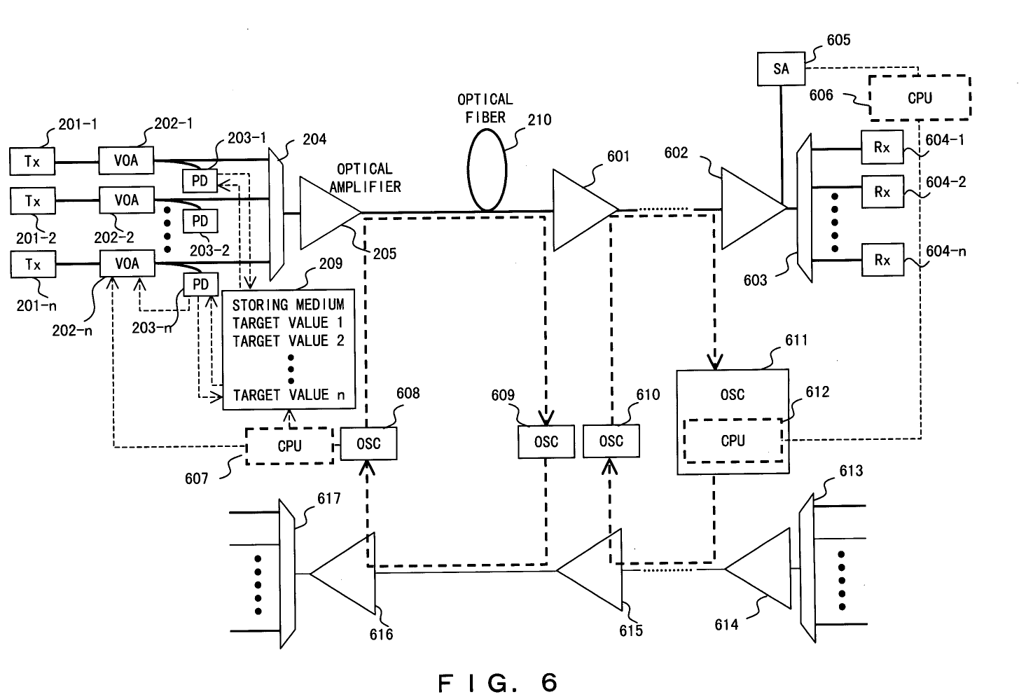

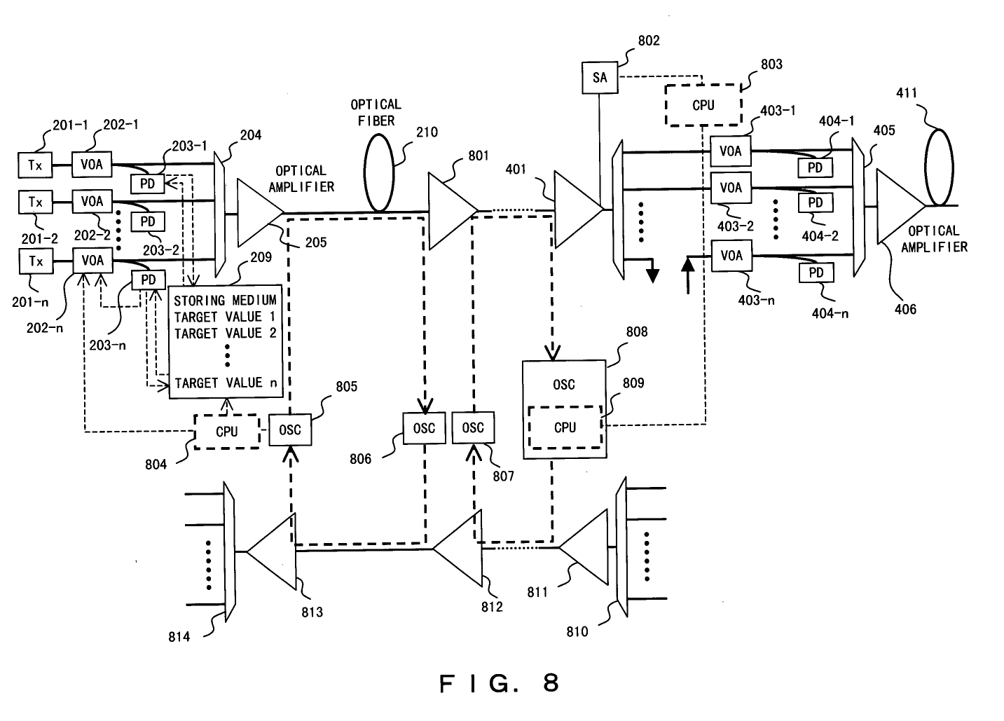

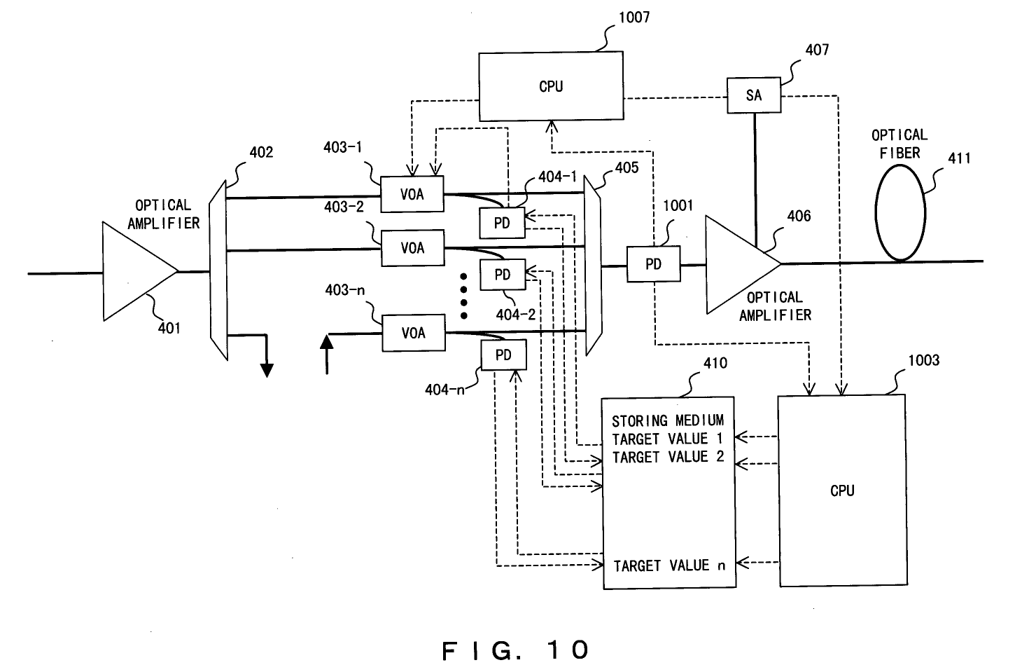

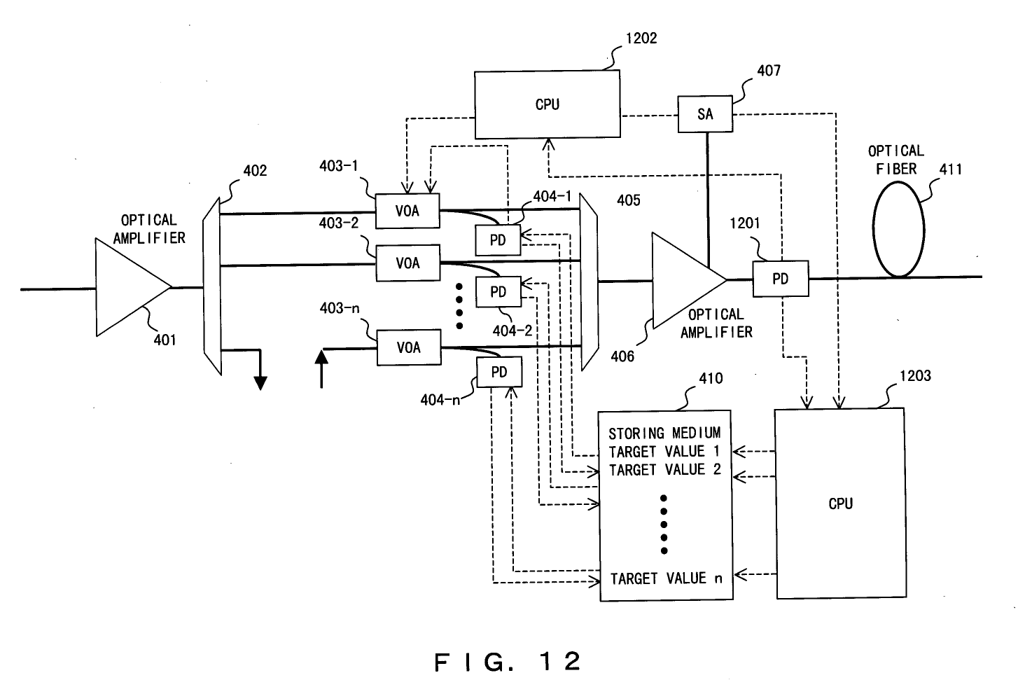

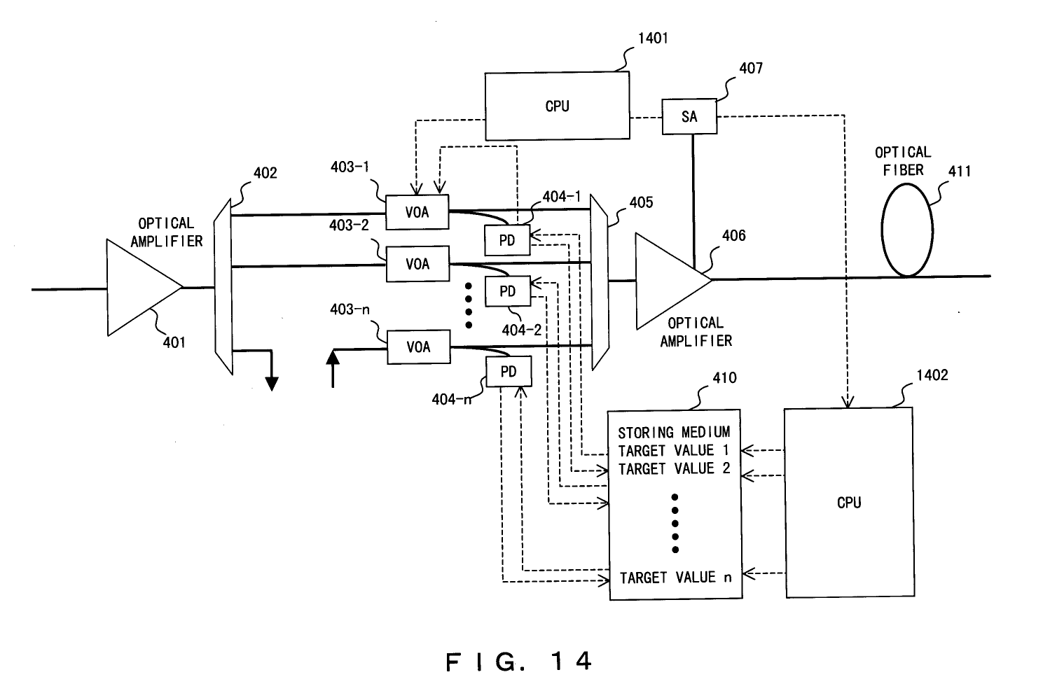

The controlling device 106 corresponds to a central processing unit (CPU) 208 of FIG. 2, a CPU 409 of FIG. 4, a CPU 607 of FIG. 6, CPU 804 of FIG. 8, a CPU 1003 of FIG. 10, a CPU 1203 of FIG. 12 or a CPU 1402 of FIG. 14, for example. The third monitoring device 107 corresponds to a PD 1001 of FIG. 10, a PD 1201 of FIG. 12 or a SA 407 of FIG. 14, for example.

According to the present invention, more accurate adjustment of optical level can be conducted rapidly by using a photodetector and an optical attenuator, in an amplifying repeater system for a wavelength multiplexed light. Further, in the above system, a delicate adjustment of a photodetector in advance is not needed.

Further, the target value of a photodetector is optimized in accordance with a change of situation of the downstream side than the optical transmission device so that the OSNR at the optical add-drop multiplexing nodes of the downstream side and the receiving nodes can be improved.

The optical transmission system for a wavelength multiplexed light of the present embodiment comprises an optical transmission line along which media with optical loss such as an optical fiber, various types of optical components or the like, and optical amplifiers for compensating for the loss by the such media are connected in tandem. Further, in the optical transmission system for a wavelength multiplexed light of the present invention, the time needed for the recovery from the shifted state of the optical level at the time of rapid variation of an optical level is reduced to the minimum and the transmission characteristics are always optimized by using both of a photodetector provided for each wavelength and an optical spectrum analyzer for monitoring, in total, the entire wavelengths so that a multi staging, an extension of distance and the like of the optical transmission system are realized.

Specifically, spectrum analyzers are arranged on transmitting nodes, receiving nodes or optical add-drop multiplexing nodes of the optical transmission system for a wavelength multiplexed light and a photodetector connected to each wavelength and variable optical attenuators are used together so that adjustments in response to situations are conducted in accordance with the number of wavelengths and the wavelength orientation. Thereby, further improvement of the transmission characteristics is realized.

Because an optical spectrum analyzer takes a long time for obtaining information (i.e. sweeping), it is inherently not suitable for a high speed control such as a transient response. However, a more accurate adjustment of optical level can be conducted in a high speed with the optical spectrum analyzer by employing a configuration that a control target value derived from a measurement result of the optical spectrum analyzer is stored in the device, taking the optical output level of a transmitting terminal, spectrum and the OSNR of a receiving terminal into account at the time of start up of the system and an increase/decrease of the wavelength so that more suitable optical level of each wavelength can be obtained by a control by a system comprising photodetectors and variable optical attenuators.

Also, in the variable optical attenuator which is to be controlled with a reference to the value monitored by the photodetector, there are two modes: high speed mode and low speed mode. These modes are respectively used for a time of start up and an increase/decrease of the wavelength, and a time of a normal operation, or used together.

By the above configuration, a rapid variation can be responded and a transmission can always be kept in the most suitable condition.

FIG. 2 shows a configuration of a transmission section provided in the transmitting node. The transmission section comprises variable optical attenuators (VOA) 202-i (i=1,2, . . . n), photodetectors (PD) 203-i (i=1,2, . . . n), an optical coupler 204, an optical amplifier 205, a spectrum analyzer (SA) 206, central processing units (CPU) 207, 208 and storing medium 209.

Among the above components, each of VOAs 202-i and each of PDs 203-i are provided for each wavelength. Each of VOAs 202-i adjusts an optical level output from each of transmitters (Tx) 201-i. And light output from the VOAs 202-i is branched into two so that one of the branched lights is input to the optical coupler 204 and the other is input to the PDs 203-i. Each of PDs 203-i monitors an optical level output from each of VOAs 202-i. The optical coupler 204 couples lights output from the VOAs 202-1 to 202-n. The optical amplifier 205 conducts an automatic level control (ALC) for output light, amplifies, as it is, the coupled light (wavelength multiplexed light), in order to output the coupled light to an optical fiber 210. The SA 206 monitors, in total, amplified light and the CPUs 207 and 208 control the VOAs 202-i and PDs 203-i by using a monitoring result of the SA 206.

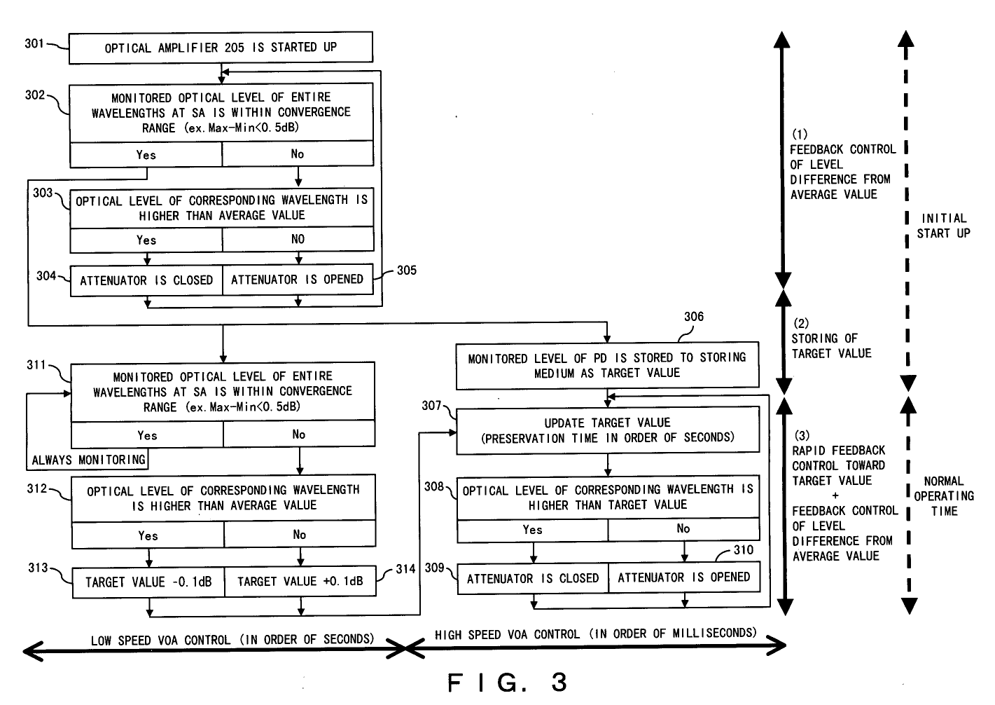

FIG. 3 is a flow chart of a control by the transmission section shown in FIG. 2. Processings of steps 302 to 306 of FIG. 3 correspond to a control at a time of initial start up. And Processings of steps 307 to 314 correspond to a control at a time of a normal operation.

(1) Feedback Control of an Optical Level Difference from an Average Value

First, when the optical amplifier 205 is started up (step 301), the SA 206 monitors the optical spectrums of the entire wavelengths range used in the system, obtains the optical level in each wavelength constituting the wavelength multiplexed light and notifies the CPU 207 of the optical level. The CPU 207 totally judges the monitored optical level of each wavelength and checks whether or not the optical level is within a convergence range (step 302). In this example, it is checked whether or not the difference between a maximum value and a minimum value of the optical level is within a range of 0.5 dB being set as a threshold value, for example.

When the monitored value of the optical level of the entire wavelengths are not within a convergence range of the optical level, the CPU 207 compares the optical level of each wavelength and the average value of the entire wavelengths (step 303) and adjusts the VOAs 202-i. Specifically when the optical level of the wavelength is higher than the average value, the CPU 207 closes the VOAs 202-i corresponding to the wavelength in order to increase the attenuation amount (step 304) and when the optical level of the wavelength is equal to or lower than the average value, the CPU opens the VOAs 202-i corresponding to the wavelength in order to decrease the attenuation amount (step 305). Thereafter, the SA 206 again monitors the optical spectrums of the entire wavelengths range used in the system.

The transmitting section repeats these processings for a time period (in the order of seconds) during which the SA 206, for example, sweeps the entire wavelengths range used in the system in order to control the optical level of each wavelength to be within the convergence range. By repeating these processings in a time period during which the SA 206 sweeps for one time, the control in a minimum necessary time unit is made possible. Also, regardless of the above conditions, these processings can be scheduled to be conducted, for example, once an hour, once a day, or at a specified arbitrary day and hour, in accordance with the variation factor of the optical level.

(2) Storing of Target Value

Next, each of PDs 203-i outputs to the storing medium 209 the monitored level of each wavelength at a time when the optical levels of the entire wavelengths got within the convergence range. The storing medium 209 stores the received monitored level from each of PDs 203-i as the target value i (step 306).

(3) Rapid feedback control toward the target value+feedback control of an optical level difference from an average value Thereafter, the transmitting section starts to operate on a high speed VOA control mode toward the stored target value (in the order of milliseconds). And the PDs 203-i monitor the optical level of each of the corresponding wavelengths and compares the monitored optical level with the target value i (step 380), and adjusts each of VOAs 202-i. When the optical level of the wavelength is higher than the target value, the VOAs 202-i corresponding to the wavelength is closed (step 309) and when the optical level of the wavelength is equal to or lower than the target value, the VOAs 202-i corresponding to the wavelength are opened (step 310). The transmitting section repeats these processings in a high speed (in the order of milliseconds).

While the above processings, the SA 206 continues to monitor the optical spectrum of the entire wavelengths range used in the system at the above described time intervals, for example and notifies the CPU 208 of the obtained optical level of each wavelength. When the optical level of each wavelength gets out of the convergence range due to the increase/decrease of the wavelength or the like, the CPU 208 updates the target value (step 307) after establishing a prescribed preservation time (in the order of seconds) for absorbing the transient response. In this example, the target value is rewrited little by little (by 0.1 dB for example) taking the difference form the average value into account so that the optical level is adjusted to be within the convergence range.

The CPU 208, in the same manner as the CPU 207, checks whether or not the monitored value of the optical level of the entire wavelengths is within a convergence range (step 311). When the monitored values of the optical levels of the entire wavelengths are not within a convergence range of the optical level, the CPU 208 compares the optical level of each wavelength and the average value of entire wavelengths (step 312). When the optical level of the wavelength is higher than the average value, the CPU 207 subtracts 0.1 dB from the corresponding target value (step 313), and when the optical level of the wavelength is equal to or lower than the average value, the CPU 207 adds 0.1 dB to the corresponding target value (step 314). And the CPU 207 updates the target value of the storing medium 209 (step 307). The transmitting section repeats these processings in a slow speed (in the order of seconds).

By conducting these controls, the optical level of each wavelength constituting the wavelength multiplexed light is ultimately controlled to be within a range of an average value of optical level of the entire wavelengths ±0.1 dB.

FIG. 4 shows a configuration of an optical add-drop multiplexing section provided in an optical add-drop multiplexing (OADM) node. The optical add-drop multiplexing section comprises the optical amplifiers 401 and 406, an optical branching filter 402, the VOAs 403-i (i=1,2, . . . n) PDs the 404-i (i=1,2, . . . n), the optical coupler 405, the SA 407, CPUs 408 and 490 and the storing medium 410.

The optical amplifier 401 amplifies the incoming light, and the optical branching filter 402 branches the amplified light into respective wavelengths. Some of VOAs 403-i adjusts the optical level of newly inserted wavelength and other VOAs 403-i adjusts the optical level of each branched wavelength passing through the above optical add-drop multiplexing node. FIG. 4 shows a newly inserted wavelength by the VOA-n, as one example. And the VOA-1 and the VOA-2 show each wavelength passing through the VOA-1 and the VOA-2.

Light output from the VOAs 403-i is branched into two so that one of the branched lights is input to the optical coupler 405 and the other is input to the PDs 404-i. Each of PDs 404-i monitors the optical level of each light output from each of VOAs 403-i. The optical coupler 405 couples each light output from each of VOA403-1 to VOA403-n. The optical amplifier 406 amplifies and outputs the coupled light to the optical fiber 411. The SA 407 monitors, in total, the amplified light, and the CPUs 408 and 409 controls the PDs 404-i through the VOAs 403-i and the storing medium 410 using the monitoring result of the SA 407.

In the optical add-drop multiplexing node, the optical level is varied at the time of start up of the entirety of the system due to the optical level adjustment for each wavelength by the transmitting node of the upstream side (input side of the optical amplifier 401 in FIG. 4) or other optical add-drop multiplexing nodes or the like, or due to the optical level adjustment or the like by the in line amplifier of the upstream side. For the above reason, the optical amplifier is started up after obtaining the start up information of each node of the upstream side from the node of the previous state (the optical transmission node, the optical add-drop multiplexing node, the in line amplifier or the like). And a rapid variation can be responded and a transmission can always be kept in the most suitable condition by the configuration that the operation on a high speed VOA control mode is started, similarly as in a transmission node, after the averaging of each wavelength while monitoring the averaging.

Especially in the optical add-drop multiplexing node, it is expected that there is a great difference among respective wavelengths because the light comes through a plurality of the in line amplifiers in the upstream side which are connected in tandem. Also, the optical add-drop multiplexing node is influenced by a rapid variation of the optical level of residual wavelength due to the variation of the number of wavelengths accompanied with the transmission failure, or by aged deteriorations of fibers, temperature variations, or the like. For the above reasons, a system which copes with a rapid variation of the number of wavelengths while always optimizing the transmission characteristics is important.

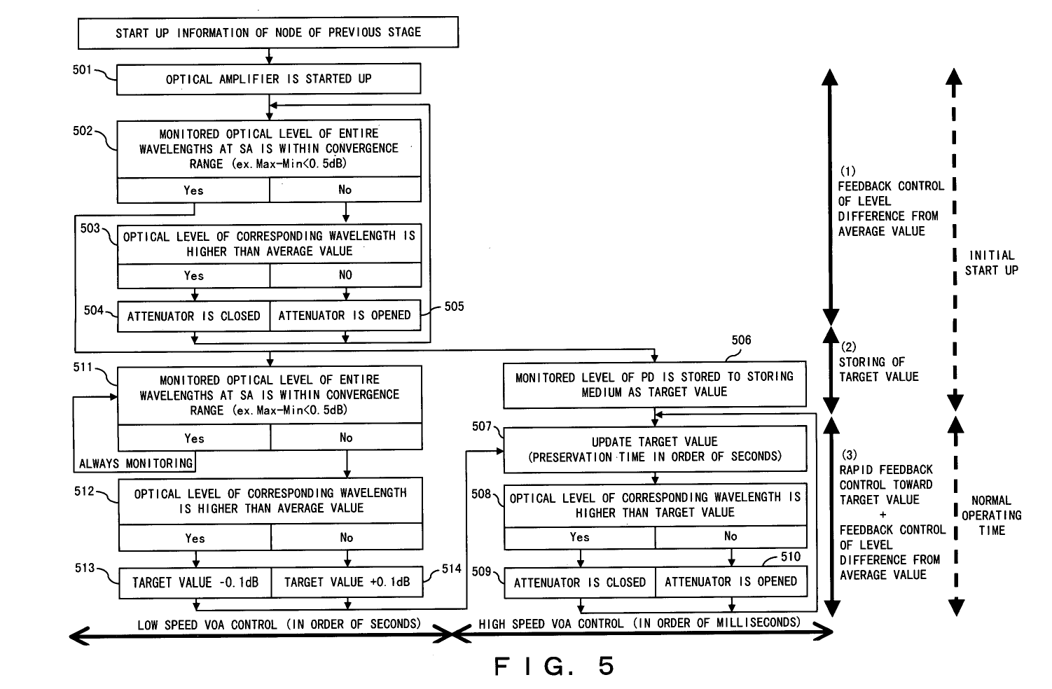

FIG. 5 is a flow chart showing a control of the optical add-drop multiplexing section shown in FIG. 4. The processings of steps 502 to 506 of FIG. 5 correspond to a control at a time of initial start up which is similar to the process of steps 302 to 306 of FIG. 3. Processings of steps 507 to 514 correspond to a control at a time of a normal operation which is similar to the process of steps 307 to 314. The CPU 408 controls the processings of steps 502 to 505, and the CPU 409 controls the processings of steps 511 to 514. Thereby, the response of the VOA403-i is controlled while the variation of the optical level occurring between the transmitting node and the optical add-drop multiplexing node, the dispersion factor of the optical level such as the variation of transmission loss, or the like are absorbed.

FIG. 6 shows a configuration of a system which adjusts the optical level so that the OSNR is constant at the receiving terminal. The system comprises the transmitters 201-i (i=1,2, . . . n), the VOAs 202-i (i=1,2, . . . n), the PDs 203-i (i=1,2, . . . n), the optical couplers 204 and 613, the optical amplifiers 205, 601, 602, 614 to 616, the storing medium 209, the optical fiber 210, optical branching filters 603 and 617, receivers 604-i (i=1,2, . . . n), SA 605, CPUs 606 and 607, and monitoring/controlling sections 608 to 611.

Among the above components, the optical amplifier 602, the optical branching filter 603, the receivers 604-i, the SA 605 and the CPU 606 constitutes the receiving section provided in the receiving node. The monitoring/controlling section 611 comprises a CPU 612. The monitoring/controlling sections 608 to 611 have functions to forward the monitoring/controlling information through the OSCs.

The optical amplifier 602 amplifies the incoming light. The optical branching filter 603 branches the amplified light to the respective wavelengths. The receivers 604-i receive the light of each of the branched lights. The SA 605 monitors, in total, the amplified light. The CPU 606, 607 and 612 controls the VOAs 202-i and the PDs 203-i by using the monitoring result of the SA 605.

In this case, the SA 605 is provided in the receiving section and the difference of the average value is calculated based on the OSNR information monitored by the SA 605. And the information is forwarded to the transmitting section through the OSC of the opposite side in order that the feedback control is conducted. Thereby, a high speed VOA control is conducted so that the OSNR at the receiving terminal is constant and a rapid variation of the optical level can be responded.

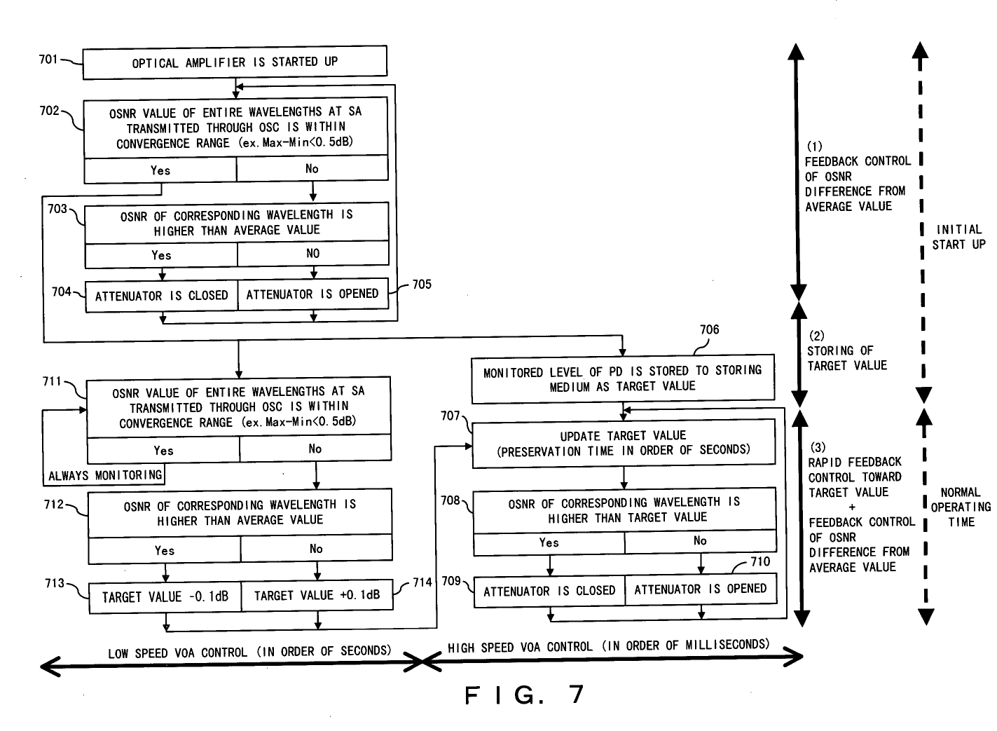

FIG. 7 is a flow chart showing a control of the system shown in FIG. 6. Processings of steps 702 to 706 of FIG. 7 correspond to a control at the time of initial start up. Processings of steps 707 to 714 correspond to a control at a time of a normal operation.

(1) Feedback Control of an OSNR Difference from an Average Value

First, when the optical amplifier 602 is started up (step 701), the SA 605 monitors OSNR value of each wavelength. The CPU 606 sends the monitored OSNR value to the transmitting section through the OSC. The CPU 607 of the transmitting section checks whether or not the received OSNR value of the entire wavelengths is within a convergence range (step 702). In this example, it is checked whether or not the difference between a maximum value and a minimum value of the OSNR is within a range of 0.5 dB, for example.

When the OSNR value of entire wavelengths is not within a convergence range, the CPU 607 compares the OSNR value of each wavelength and the average value of the entire wavelengths (step 703) and adjusts the VOAs 202-i. When the OSNR value of the wavelength is higher than the average value, the CPU 207 closes the VOAs 202-i corresponding to the wavelength (step 704) and when the OSNR value of the wavelength is equal to or lower than the average value, the CPU 207 opens the VOAs 202-i corresponding to the wavelength (step 705). Thereafter, the SA 605 again monitors the OSNR of each wavelength.

These processings are repeated in a slow speed (in the order of seconds). And a feedback control is conducted so that the OSNR value is constant at the receiving terminal.

(2) Storing of Target Value

Next, each of PDs 203-i outputs to the storing medium 209 the monitored level of each wavelength at a time when the OSNR value of the entire wavelengths got within the convergence range. The storing medium 209 stores the received monitored level from each of PDs 203-i as the target value i (step 706).

(3) Rapid Feedback Control Toward the Target Value+Feedback Control of an OSNR Difference from an Average Value

Thereafter, the transmitting section starts to operate on a high speed VOA control mode (in the order of milliseconds) toward the stored target value. The processings of steps 708 to 710 are the same as the processings of steps 308 to 310.

While the above processings, the CPU 607 always monitors the OSNR value based on the OSNR information from the receiving section. When the OSNR value of each wavelength gets out of the convergence range due to the increase/decrease of the wavelength or the like, the CPU 607 updates the target value (step 707) after establishing a prescribed preservation time. In this example, the target value is rewrited little by little (by 0.1 dB for example) so that the OSNR value is adjusted to be constant.

The CPU 607, in the same manner as in the step 702, checks whether or not the OSNR value of the entire wavelengths is within a convergence range (step 711). When the OSNR value of the entire wavelengths is not within a convergence range, the CPU 607 compares the OSNR value of each wavelength and the average value of the entire wavelengths (step 712). When the OSNR value of the wavelength is higher than the average value, the CPU 607 subtracts 0.1 dB from the corresponding target value (step 713), and when the OSNR value of the wavelength is equal to or lower than the average value, the CPU 607 adds 0.1 dB to the corresponding target value (step 714). And the CPU 607 updates the target value of the storing medium 209 (step 707). These processings are repeated in a slow speed (in the order of seconds).

Also, the calculation of the OSNR value and of the difference of the average values or of the target value of each wavelength do not have to be conducted necessarily by the CPU 607 of the transmitting section and can be conducted by the CPU 606 of the receiving section, CPU 612 of the monitoring/controlling section 611, or other monitoring/controlling sections.

FIG. 8 shows a configuration of a system which adjusts the optical level so that the OSNR of the incoming light in the optical add-drop multiplexing node is constant. The system comprises the transmitters 201-i (i=1,2, . . . n), the VOAs 202-i and 403-i (i=1,2, . . . n), the PDs 203-i (i=1,2, . . . n) and 404-i (i=1,2, . . . n), the optical couplers 204, 405 and 810, the optical amplifiers 205, 401, 406 and 811 to 813, the storing medium 209, the optical fibers 210 and 411, the optical branching filters 402 and 814, SA 802, CPUs 803 and 804, and the monitoring/controlling sections 805 to 808.

Among the above components, the optical amplifiers 401 and 406, the optical branching filter 402, the VOAs 403-i, PDs 404-i, the optical coupler 405, the SA 802, and the CPU 803 constitutes the optical add-drop multiplexing section, and the monitoring/controlling section 808 comprises the CPU 809. The monitoring/controlling sections 805 to 808 have functions to forward the monitoring/controlling information through the OSCs.

The SA 802 monitors, in total, the amplified light by the optical amplifier 401 of the receiving side. The CPUs 803, 804 and 809 control the VOAs 202-i and PDs 203-i by using the monitoring result of the SA 802.

According to the above configuration, the OSNR at the destined receiving node is kept to be the most suitable value and the variation of the optical level such as the an increase/decrease of the wavelength or the like can be absorbed during the transmission by making the OSNR in the unit of optical add-drop multiplexing node constant so that the variation of the optical level at the receiving node can be mitigated.

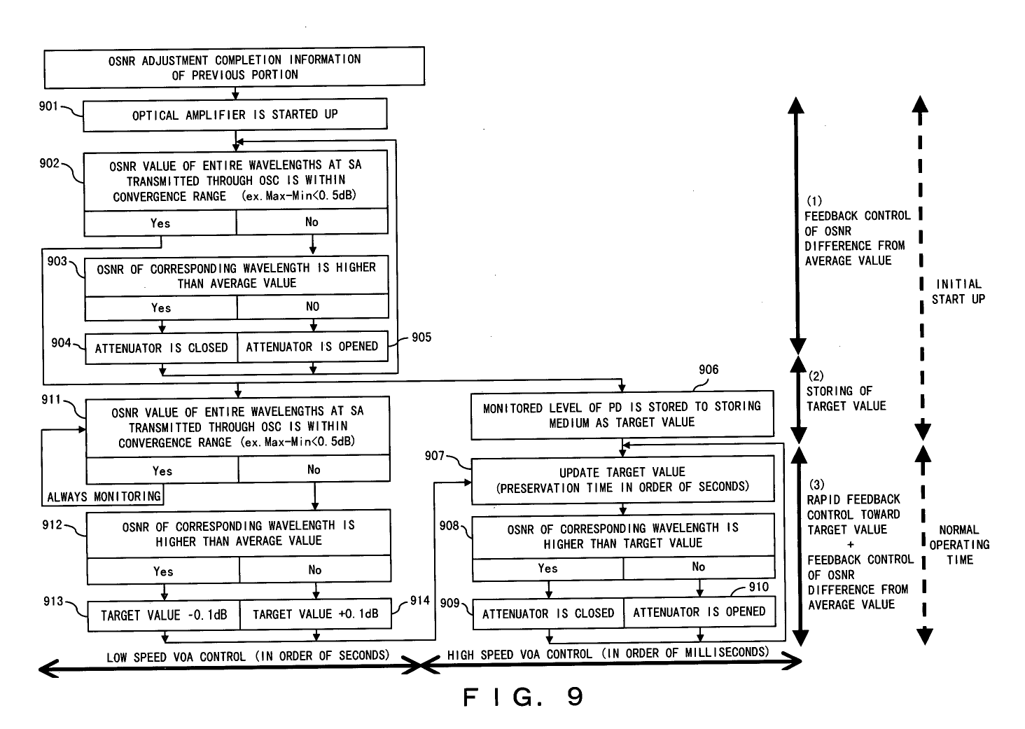

FIG. 9 is a flow chart showing a control a system shown in FIG. 8. In a case of the system of FIG. 8, it is necessary that the OSNR adjustments on the portions between the transmitting section of the upstream side from the optical add-drop multiplexing section or the optical add-drop multiplexing section and that optical add-drop multiplexing section are finished. The information indicating that the OSNR adjustments are finished is obtained from the SA 802 at the input side of the optical add-drop multiplexing section.

The processings of steps 902 to 906 of FIG. 9 correspond to a control at a time of initial start up which is similar to the process of steps 702 to 706 of FIG. 7. Processings of steps 907 to 914 correspond to a control at a time of normal operation which is similar to the process of steps 707 to 714 of FIG. 7. The CPU 804 controls the processings of steps 902 to 905 and of steps 911 to 914. Thereby, the response of the VOA403-i is controlled while the OSNR between the transmitting node and OSNR.

Also, the calculation of the OSNR value and of the difference of the average values or of the target value of each wavelength do not have to be conducted necessarily by the CPU 804 of the transmitting section but can be conducted by the CPU 803 of the receiving section, CPU 809 of the monitoring/controlling section 808, or other monitoring/controlling sections.

FIG. 10 shows a configuration of an optical add-drop multiplexing section in a case that the optical amplifier in the outputting side conducts automatic gain control (AGC). The optical add-drop multiplexing section of FIG. 10 has the same configuration as the optical add-drop multiplexing section of FIG. 4 except for that in the optical add-drop multiplexing section of the FIG. 10, a PD 1001 is provided between the optical coupling 405 and the optical amplifier 406, and the CPUs 408 and 409 are respectively replaced by CPUs 1002 and 1003.

In a case that the optical amplifier 406 of outputting side is conducting AGC, the optical level of the incoming light has to be kept constant so that the optical level of the incoming light does not vary. Therefore, a control has to be conducted by using both of information about a dispersion of each wavelength from the SA 407 and the information from the PD 1001 at the input side of the optical amplifier, monitoring the optical level of the total power in order to keep the output to be constant, to suppress the dispersion and to respond to a rapid variation. Also, the PD 1001 can be incorporated in the optical amplifier 406.

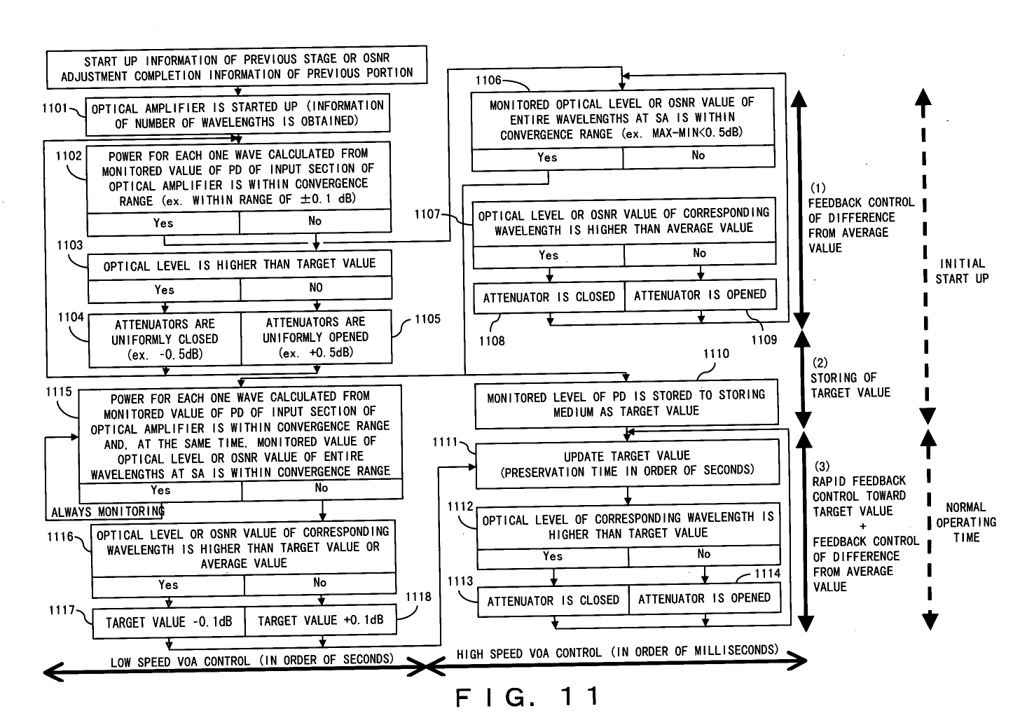

FIG. 11 is a flow char showing a control of the optical add-drop multiplexing section shown in FIG. 10. Processings of steps 1101 to 1110 correspond to a control at a time of initial start up. Processings of steps 1111 to 1118 correspond to a control of a normal operation.

(1) Feedback Control of a Difference from an Average Value

First, the optical add-drop multiplexing section starts up the optical amplifier after obtaining information of the start up of the upstream or OSNR adjustment completion information through the OSC and obtains information of the number of wavelengths (step 1101). Next, the PD 1001 monitors the optical level of the total power of the entire wavelengths. The CPU 1002 calculates a power for each one wave by dividing the number of wavelengths to the monitored value of the PD1001 and checks whether or not the power for each one wave is within a convergence range (step 1102). In this example, it is checked whether or not the power for each one wave is within a range of ±0.1 dB.

When the power for each one wave is not within a convergence range, the CPU 1002 compares the monitored optical level and the prescribed target value (step 1103) and adjusts the VOAs 403-i. When the optical level is higher than the target value, the CPU 1002 uniformly closes the VOAs 403-i of the entire wavelengths (step 1104) and when the optical level is equal to or lower than the target value, the CPU 1002 opens the VOAs 202-i corresponding to the wavelength (step 1105). In the step 1104, the attenuation amount is increased by 0.5 dB, for example, and in the step 1105, the attenuation amount is decreased by 0.5 dB, for example. Thereafter, the PD 1001 again monitors the optical level. The optical add-drop multiplexing section repeats these processings in a low speed (in the order of seconds).

Next, when the power for each one wave gets within a convergence range, the SA 407 monitors an optical level or the OSNR value of each wavelength and the CPU 1002 checks whether or not the monitored value of the optical level or the OSNR value of the entire wavelengths is within a convergence range (step 1106).

When the monitored values of the optical levels or the OSNR value of the entire wavelengths is not within a convergence range, the CPU 1002 compares the optical level or the OSNR value of each wavelength and the average value of the entire wavelengths (step 1107) and adjusts the VOAs 403-i. When the optical level or the OSNR value of the wavelength is higher than the average value, the CPU 1002 closes the VOAs 403-i corresponding to the wavelength (step 1108) and when the optical level or the OSNR value of the wavelength is equal to or lower than the average value, the CPU 1002 opens the VOAs 403-i corresponding to the wavelength (step 1109). Thereafter, the SA 407 again monitors the optical level or the OSNR value of the entire wavelengths. These processings are repeated in a high speed (in the order of milliseconds)

(2) Storing of Target Value

Next, each of PDs 404-i outputs to the storing medium 410 the monitored level of each wavelength at a time when the monitored level of the optical level or the OSNR value of the entire wavelengths got within the convergence range. The storing medium 410 stores the received monitored level from each of PDs 404-i as the target value i (step 1110).

(3) Rapid Feedback Control Toward the Target Value+Feedback Control of a Difference from an Average Value

Thereafter, the transmitting section starts to operate on a high speed VOA control mode toward the stored target value (in the order of milliseconds). The processings of steps 1112 to 1114 are the same as the processings of steps 308 to 310.

While the above processings, the CPU 1003, in the same manner as the CPU 1002, checks whether or not a power for each one wave is within a convergence range and, at the same time, the monitored value or the OSNR value of the optical level of the entire wavelengths is within a convergence range (step 1115). And when the above conditions are not satisfied, the CPU 1003 compares the optical level of each wavelength and the corresponding average value and also compares the optical level or the OSNR value of each wavelength and the average value of the entire wavelengths (step 1116).

When the optical level of each wavelength is higher than the target value or when the optical level or the OSNR value of the wavelength is higher than an average value, the CPU 1003 subtracts 0.1 dB from the corresponding target value (step 1117), and when the optical level of the wavelength is equal to or lower than the average value and, at the same time, the optical level or the OSNR value of the wavelength is equal to or lower than the average value, the CPU 1003 adds 0.1 dB to the corresponding target value (step 1118). And the CPU 1003 updates the target value of the storing medium 410 (step 1111). The optical add-drop multiplexing section repeats these processings in a slow speed (in the order of seconds).

In a configuration of FIG. 10, the monitored value of PD 1001 provided at the input side of the optical amplifier 406 is kept to be constant so that a level of output light of the optical amplifier of AGC is kept to be constant, however, it is similarly possible that the level of output light of the optical amplifier of AGC is kept to be constant by keeping the monitored value of the PD 1001 provided at the output side of the optical amplifier 406.

FIG. 12 shows a configuration of the above optical add-drop multiplexing section. The optical add-drop multiplexing section of FIG. 12 has the same configuration as the optical add-drop multiplexing section of FIG. 10 except for that in the optical add-drop multiplexing section of the FIG. 12, a PD 1201, in place of the PD 1001, is provided at the output side of the optical amplifier 406, and the CPUs 1002 and 1003 are respectively replaced by CPUs 1202 and 1203.

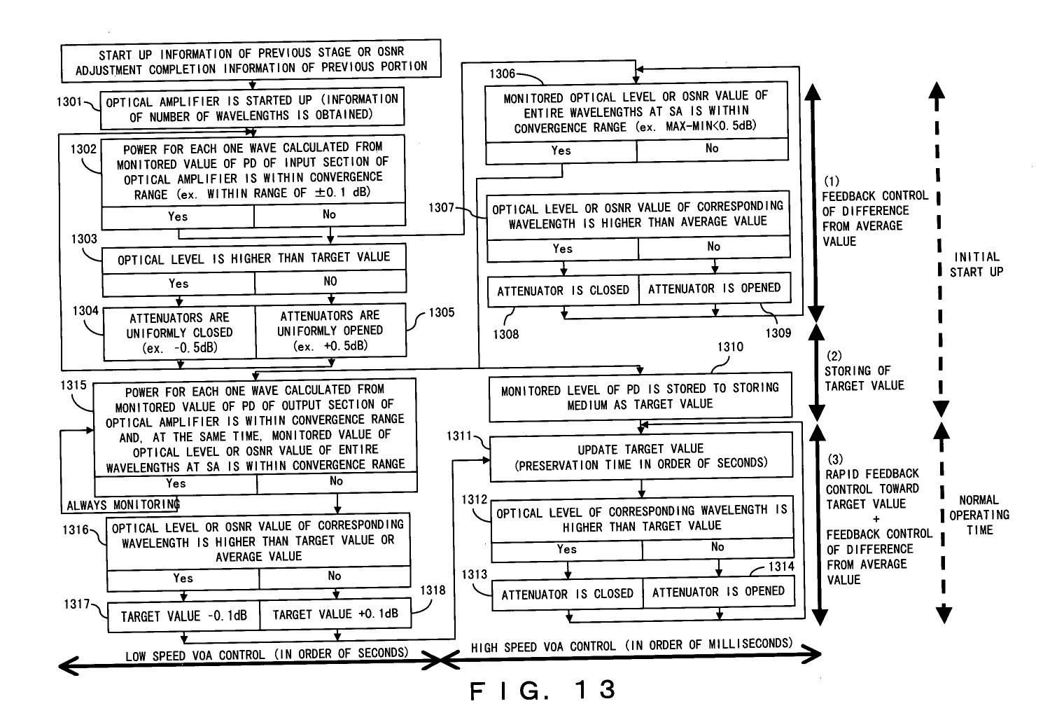

FIG. 13 is a flow chart showing a control of the optical add-drop multiplexing section shown in FIG. 12. Processings of steps 1302 to 1310 of FIG. 13 correspond to a control at a time of initial start up which is similar to the process of steps 1102 to 1110 of FIG. 11. And processings of steps 1311 to 1318 correspond to a control at a time of normal operation which is similar to that of steps 1111 to 1118 of FIG. 11. The CPU 1202 controls the processings of steps 1302 to 1309. The CPU 1203 controls the processings of steps 1315 to 1318.

Further, when automatic level control just for the compensating for the optical level due to such a smooth variation of loss as aged deteriorations, temperature variations or the like of the optical fiber of the transmission line is to be conducted, the SA 407 can be used in place of the PD 1201 of FIG. 12. Especially in a configuration of a system in which only the optical amplifier conducts a control independently, such a replacement as above is needed.

FIG. 14 shows a configuration of such an optical add-drop multiplexing section as described above. The optical add-drop multiplexing section of FIG. 14 has the same configuration as the optical add-drop multiplexing section of FIG. 12 except for that in the optical add-drop multiplexing section of the FIG. 14, the PD 1201 is removed and the CPUs 1202 and 1203 are respectively replaced by CPUs 1401 and 1402.

In this case, the absolute value of the optical level of each wavelength is obtained from the SA 407 and each of VOAs 403-i for each wavelength is adjusted so that an average value of the above obtained absolute value (a power for each one wave) is adjusted to be the optical level as the target value. In this method, information of the branching ratio at the time when the light is branched from the main signal to the SA 407 in advance and the power accuracy of the SA 407 enough to seek for the level of absolute light are needed. Also, in this method, amplified spontaneous emission (ASE) correction can be conducted simultaneously in order to adjust the average value only of the signal light to the target value.

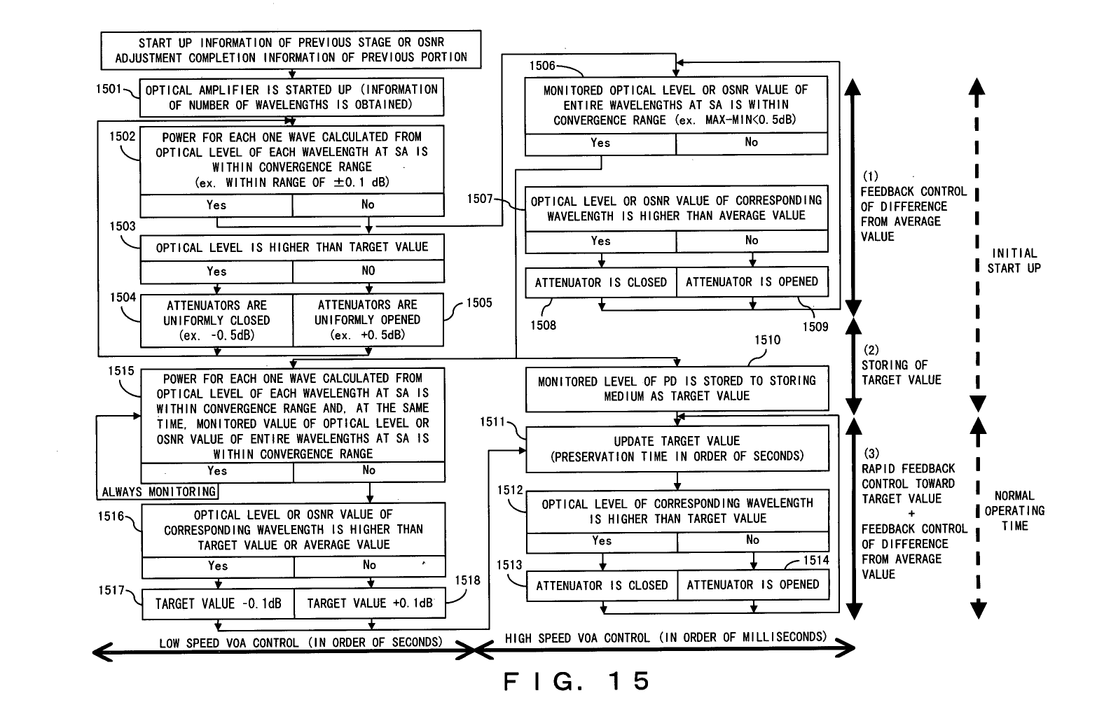

FIG. 15 is a flow chart for showing a control of the optical add-drop multiplexing section shown in FIG. 14. Processings of steps 1502 to 1510 of FIG. 15 correspond to a control at a time of initial start up which is similar to the process of steps 1302 to 1310 of FIG. 13. And Processings of steps 1511 to 1518 correspond to a control at a time of a normal operation which is similar to the process of steps 1311 to 1318 of FIG. 13. The CPU 1401 controls the processings of steps 1502 to 1509. The CPU 1402 controls the processings of steps 1515 to 1518.

Also, in FIGS. 10 to 15, a configuration and operations of the optical add-drop multiplexing section are shown, however, also in the transmitting section of the transmitting node, a control can be conducted by the same configuration. For example, when the optical amplifier 205 is conducting the AGC in the transmitting section of FIG. 2, information necessary for conducting an automatic level control can be obtained by providing the PD at the input side or the output side of the optical amplifier 205, or by using the SA 206.

Also, as a storing medium for storing the above described target value, EEPROM (Electronically Erasable and Programmable Read Only Memory) can be used, for example. And as the CPU for conducting the above described control, FPGA (Field Programmable Gate Array) can be used, for example.

Further, in the respective embodiments described above, an optical level of each wavelength is adjusted to an average value of the entire wavelengths, however, not limited to the above, a control can be conducted in order to obtain the desired spectrum shape.

For example, the desired spectrum shape can be obtained by employing a configuration that difference information indicating the difference from the average value in each wavelength is set in the CPU 208 of FIG. 2 as the controlling means in advance and, in step 302 of FIG. 3, a comparison is made between the optical level of the wavelength measured by the SA and the optical level set by modifying the average value based on the difference information of the corresponding wavelength in order to adjust the optical attenuator when there is a difference equal to or greater than 0.1 dB.

Further, in the respective embodiments described above, for example, the PD can have a configuration that the PD comprises an optical bus system and an optical level detector, and that one of the incoming lights branched by the optical bus system is guided to the optical level detector to measure the optical level and the other light is guided to an optical coupler.

What is claimed is:

1. An optical transmission device for transmitting a wavelength multiplexed light obtained by multiplexing lights of plural wavelengths through an optical transmission line including media with optical loss and optical amplifying devices for compensating for the loss by such media, comprising:
a storing device for storing a target value of an optical level of each wavelength;
a first monitoring device for monitoring an optical level of each wavelength;
an optical attenuating device for adjusting an optical level of each wavelength so that a monitored value of the first monitoring device gets closer to the target value stored in the storing device;
an optical coupling device for coupling the adjusted light of each wavelength;
a second monitoring device for monitoring, in total, an optical level of each wavelength after the coupling; and
a controlling device for updating the target value stored in the storing device in accordance with the monitored value of the second monitoring device.

2. The optical transmission device according to claim 1, wherein, when an optical level of the entire wavelengths monitored by the second monitoring device is not within a predetermined convergence range, the controlling device decreases a target value of a wavelength with an optical level higher than an average value of the entire wavelengths, and increases a target value of a wavelength with an optical level lower than the average value.

3. The optical transmission device according to claim 1, wherein the optical amplifying device is provided in the optical add-drop multiplexing node and is started up after receiving start up information from the node of previous stage.

4. An optical transmission device for transmitting a wavelength multiplexed light obtained by multiplexing lights of plural wavelengths through an optical transmission line including media with optical loss and optical amplifying devices for compensating for the loss by such media, comprising:
a storing device for storing a target value of an optical level of each wavelength;
a monitoring device for monitoring an optical level of each wavelength;
an optical attenuating device for adjusting an optical level of each wavelength so that a monitored value of the monitoring device gets closer to the target value stored in the storing device;
an optical coupling device for coupling the adjusted light of each wavelength; and
a controlling device for receiving information of optical signal-noise-ratio obtained by monitoring, in total, optical signal-noise-ratio of each wavelength after the coupling and for updating the target value stored in the storing device in accordance with the received information of optical signal-noise-ratio.

5. The optical transmission device according to claim 4, wherein, when an optical signal-noise-ratio of the entire wavelengths is not within a predetermined convergence range, the controlling device decreases a target value of a wavelength with an optical signal-noise-ratio higher than an average value of the entire wavelengths, and increases a target value of a wavelength with an optical signal-noise-ratio lower than the average value.

6. The optical transmission device according to claim 4, wherein the optical amplifying device is provided in the optical add-drop multiplexing node, and is started up after receiving optical signal-noise-ratio adjustment completion information from a transmitting node to the optical add-drop multiplexing node.

7. An optical transmission device for transmitting a wavelength multiplexed light obtained by multiplexing lights of plural wavelengths through an optical transmission line including media with optical loss and optical amplifying devices for conducting automatic gain control to compensate for the loss by such media, comprising:
a storing device for storing a target value of an optical level of each wavelength;
a first monitoring device for monitoring an optical level of each wavelength;
an optical attenuating device for adjusting an optical level of each wavelength so that a monitored value of the first monitoring device gets closer to the target value stored in the storing device;
an optical coupling device for coupling the adjusted light of each wavelength;
a second monitoring device for monitoring, in total, an optical level or an optical signal-noise-ratio of each wavelength after the coupling;
a third monitoring device for monitoring an optical level of a total power after the coupling at the input side or the output side of the optical amplifying device; and
a controlling device for updating the target value stored in the storing device in accordance with the monitored value of the second monitoring device and the third monitoring device.

8. The optical transmission device according to claim 7, wherein, when an optical level or an optical signal-noise-ratio of the entire wavelengths monitored by the second monitoring device is not within a predetermined convergence range or when a power for each one wave which is calculated based on the monitored value of the third monitoring device is not within the convergence range, the controlling device decreases the target value of a wavelength with an optical level higher than the target value, and increases the target value of a wavelength with an optical level lower than the target value.

9. The optical transmission device according to claim 8, wherein, when an optical level or an optical signal-noise-ratio of the entire wavelengths monitored by the second monitoring device is not within a predetermined convergence range or when a power for each one wave which is calculated based on the monitored value of the third monitoring device is not within the predetermined convergence range, the controlling device decreases a target value of a wavelength with an optical level or an optical signal-noise-ratio higher than an average value of the entire wavelengths, and increases a target value of a wavelength with an optical level or an optical signal-noise-ratio lower than the average value.

10. The optical transmission device according to claim 7, wherein the optical amplifying device is provided in the optical add-drop multiplexing node, and is started up after receiving start up information from the node of previous stage or after receiving the optical signal-noise-ratio adjustment completion information from a transmitting node to the optical add-drop multiplexing node.

11. An optical transmission method of transmitting a wavelength multiplexed light obtained by multiplexing lights of plural wavelengths through an optical transmission line including media with optical loss and optical amplifying devices for compensating for the loss by such media, wherein:
monitoring an optical level of each wavelength;
adjusting an optical level of each wavelength so that the monitored value of the optical level of each wavelength gets closer to the target value;
coupling the adjusted light of each wavelength;
monitoring an optical level of each wavelength after the coupling, in total; and
updating the target value in accordance with the monitored value of an optical level of each wavelength after the coupling.

12. An optical transmission method of transmitting a wavelength multiplexed light obtained by multiplexing lights of plural wavelengths through an optical transmission line including media with optical loss and optical amplifying devices for conducting automatic gain control to compensate for the loss by such media, wherein:
monitoring an optical level of each wavelength;
adjusting an optical level of each wavelength so that the monitored value of the optical level of each wavelength gets closer to the target value;
coupling the adjusted light of each wavelength;
monitoring an optical level or an optical signal-noise-ratio of each wavelength after the coupling, in total;
monitoring an optical level of a total power after the coupling at the input side or the output side of the optical amplifying device;
updating the target value in accordance with a monitored value of an optical level or an optical signal-noise-ratio of each wavelength after the coupling and the monitored value of an optical level of a total power after the coupling.

13. An optical transmission device for transmitting a wavelength multiplexed light obtained by multiplexing lights of plural wavelengths through an optical transmission line including media with optical loss and optical amplifying devices for compensating for the loss by such media, comprising:
storing means for storing a target value of an optical level of each wavelength;
first monitoring means for monitoring an optical level of each wavelength;
optical attenuating means for adjusting an optical level of each wavelength so that a monitored value of the first monitoring means get closer to the target value stored in the storing means;
optical coupling means for coupling the adjusted light of each wavelength;
second monitoring means for monitoring, in total, an optical level of each wavelength after the coupling; and
controlling means for updating the target value stored in the storing means in accordance with the monitored value of the second monitoring means.

14. An optical transmission device for transmitting a wavelength multiplexed light obtained by multiplexing lights of plural wavelengths through an optical transmission line including media with optical loss and optical amplifying devices for compensating for the loss by such media, comprising:
storing means for storing a target value of an optical level of each wavelength;
monitoring means for monitoring an optical level of each wavelength;
optical attenuating means for adjusting an optical level of each wavelength so that a monitored value of the monitoring means get closer to the target value stored in the storing means;
optical coupling means for coupling the adjusted light of each wavelength; and
controlling means for receiving information of optical signal-noise-ratio obtained by monitoring, in total, optical signal-noise-ratio of each wavelength after the coupling and for updating the target value stored in the storing means in accordance with the received information of optical signal-noise-ratio.

15. An optical transmission device for transmitting a wavelength multiplexed light obtained by multiplexing lights of plural wavelengths through an optical transmission line including media with optical loss and optical amplifying devices for conducting automatic gain control to compensate for the loss by such media, comprising:
storing means for storing a target value of an optical level of each wavelength;
first monitoring means for monitoring an optical level of each wavelength;
optical attenuating means for adjusting an optical level of each wavelength so that a monitored value of the first monitoring means get closer to the target value stored in the storing means;
optical coupling means for coupling the adjusted light of each wavelength;
second monitoring means for monitoring, in total, an optical level or an optical signal-noise-ratio of each wavelength after the coupling;
third monitoring means for monitoring an optical level of a total power after the coupling at the input side or the output side of the optical amplifying means; and
controlling means for updating the target value stored in the storing means in accordance with the monitored value of the second monitoring means and the third monitoring means.
